(19) United States
(12) Patent Application Publication
(10) Pub. No.: US 2023/0050079 A1
(43) Pub. Date: Feb. 16, 2023

(54) TEXT RECOGNITION METHOD, ELECTRONIC DEVICE, AND NON-TRANSITORY STORAGE MEDIUM

(71) Applicant: BEIJING BAIDU NETCOM SCIENCE TECHNOLOGY CO., LTD., Beijing (CN)

(72) Inventors: Pengyuan LV, Beijing (CN); Xiaoyan WANG, Beijing (CN); Liang WU, Beijing (CN); Shanshan LIU, Beijing (CN); Yuechen YU, Beijing (CN); Meina QIAO, Beijing (CN); Jie LU, Beijing (CN); Chengquan ZHANG, Beijing (CN); Kun YAO, Beijing (CN)

(73) Assignee: BEIJING BAIDU NETCOM SCIENCE TECHNOLOGY CO., LTD., Beijing (CN)

(21) Appl. No.: 17/974,630

(22) Filed: Oct. 27, 2022

(30) Foreign Application Priority Data
Apr. 8, 2022 (CN) 2022103678976

(51) Int. Cl. G06V 30/18; G06V 30/148

(52) U.S. Cl. CPC G06V 30/18; G06V 30/148

(57) ABSTRACT

Provided are a text recognition method, an electronic device, and a non-transitory computer-readable storage medium, which are applicable in an OCR scenario. In the particular solution, a text image to be recognized is acquired. Feature extraction is performed on the text image, to obtain an image feature corresponding to the text image, where a height-wise feature and a width-wise feature of the image feature each have a dimension greater than 1. According to the image feature, sampling features corresponding to multiple sampling points in the text image are determined. According to the sampling features corresponding to the multiple sampling points, a character recognition result corresponding to the text image is determined.

### CROSS-REFERENCE TO RELATED APPLICATION

This application claims priority to Chinese Patent Application No. 202210367897.6, filed on Apr. 8, 2022, which is hereby incorporated by reference in its entirety.

### TECHNICAL FIELD

The present disclosure relates to the field of artificial intelligence, in particular to the technical fields of deep learning, image processing and computer vision, and more particularly to a text recognition method, an electronic device, and a non-transitory storage medium, which are applicable in an Optical Character Recognition (OCR) scenario.

### BACKGROUND

Artificial intelligence is a discipline that conducts research to make computers to simulate some thinking processes and intelligent behaviors of people (such as learning, reasoning, thinking, planning), which involves both the hardware technology and the software technology. The hardware technology used for artificial intelligence generally include technologies related to sensors, dedicated artificial intelligence chips, cloud computing, cloud distributed storage, and big data processing, etc. The software technology used for artificial intelligence mainly includes computer vision technology, speech recognition technology, natural language processing technology and machine learning/deep learning, big data processing technology, knowledge graph technology, etc.

With the development of artificial intelligence, the Optical Character Recognition (OCR) technology is widely used in various fields, including but not limited to education, medical care, finance, insurance and other business fields. In practical application scenarios, there may be various styles of characters in the text, such as oblique characters, curved characters, and handwritten characters. Therefore, it is necessary to provide a text recognition solution capable of recognizing characters of any style.

### SUMMARY

The present disclosure provides a text recognition method, an electronic device, and a non-transitory storage medium.

According to a first aspect of the present disclosure, there is provided a text recognition method, including:

performing feature extraction on a text image to be recognized, to obtain an image feature corresponding to the text image, where a height-wise feature and a width-wise feature of the image feature each have a dimension greater than 1;

determining, according to the image feature, sampling features corresponding to multiple sampling points in the text image; and

determining, according to the sampling features corresponding to the multiple sampling points, a character recognition result corresponding to the text image.

According to a second aspect of the present disclosure, there is provided an electronic device, including:

at least one processor; and

a memory communicating with the at least one processor;

where the memory stores therein instructions executable by the at least one processor, and the instructions are executed by the at least one processor to cause the at least one processor to perform the method according to the first aspect.

According to a third aspect of the present disclosure, there is provided a non-transitory computer-readable storage medium storing computer instructions, the computer instructions are configured to cause a computer to perform a method. In the method, an image to be recognized is acquired, where the image includes at least one character. Feature extraction is performed on the image, to obtain an image feature corresponding to the image, where a height-wise feature and a width-wise feature of the image feature each have a dimension greater than 1. According to the image feature, sampling features corresponding to a plurality of sampling points in the image are determined. According to the sampling features corresponding to the plurality of sampling points, a character recognition result for the at least one character of the image is determined.

It should be understood that the contents described in this section are not intended to identify key or critical features of the embodiments of the present disclosure, nor are they intended to limit the scope of the present disclosure. Other features of the present disclosure will become readily understood from the following description.

### BRIEF DESCRIPTION OF THE DRAWINGS

The accompanying drawings are provided for better understanding of the solutions, and they do not constitute a limitation to the present disclosure, in which:

FIG. 1 is a schematic diagram illustrating some text images provided by the embodiments of the present disclosure.

FIG. 2 is a schematic flowchart of a text recognition method provided by an embodiment of the present disclosure.

FIG. 3 is a schematic flowchart of another text recognition method provided by an embodiment of the present disclosure.

FIG. 4 is a schematic diagram illustrating a text recognition process provided by the embodiments of the present disclosure.

FIG. 5 is a schematic diagram of a system architecture involved in the embodiments of the disclosure.

FIG. 6 is a schematic flowchart of a further text recognition method provided by an embodiment of the present disclosure.

FIG. 7 is a schematic structural diagram of a text recognition model provided by an embodiment of the present disclosure.

FIG. 8 is a schematic flowchart of a method for training a text recognition model provided by an embodiment of the present disclosure.

FIG. 9 is a schematic structural diagram of a text recognition apparatus provided by an embodiment of the present disclosure.

FIG. 10 is a schematic structural diagram of an apparatus for training a text recognition model provided by an embodiment of the present disclosure.

FIG. 11 is a schematic structural diagram of an electronic device provided by an embodiment of the present disclosure.

### DESCRIPTION OF EMBODIMENTS

The exemplary embodiments of the present disclosure are described below with reference to the accompanying drawings, including various details of the embodiments of the present disclosure that are useful for understanding the present disclosure, which should be considered as merely exemplary. Therefore, those of ordinary skill in the art should realize that various changes and modifications can be made to the embodiments described herein without departing from the scope and spirit of the present disclosure. Likewise, for clarity and conciseness, descriptions of well-known functions and structures are omitted below.

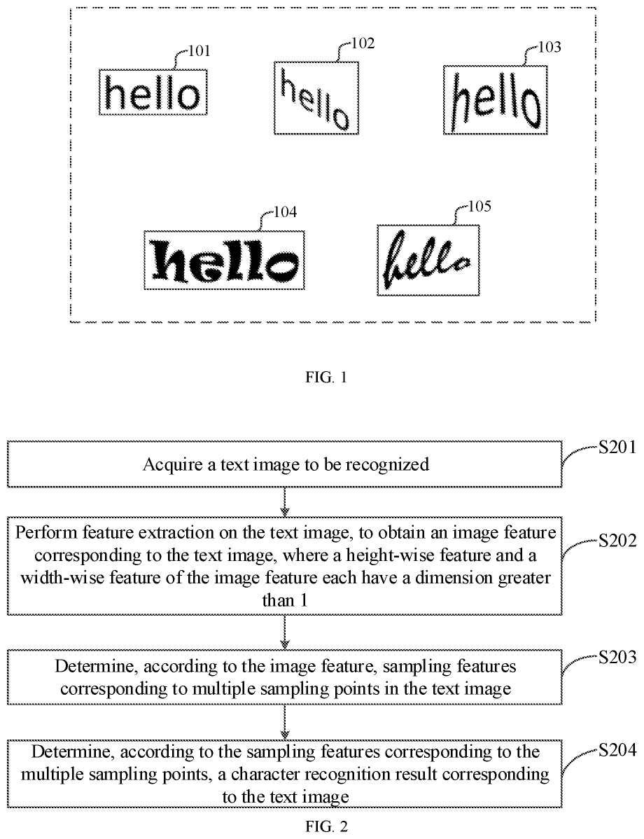

In practical application scenarios, there may be various styles of characters in the text, which makes it difficult for text recognition. FIG. 1 is a schematic diagram illustrating some text images provided by the embodiments of the present disclosure. Referring to FIG. 1, image 101 illustrates a text image in a natural scenario, in which characters are arranged horizontally and are clear and easy to be recognized. Image 102 illustrates a text image including oblique characters. Image 103 illustrates a text image including curved characters. Image 104 illustrates a text image including characters of special font. Image 105 illustrates a text image including handwritten characters in joined-up writing. It should be understood that, in practical applications, in addition to the characters of complex styles shown in the above image 102 to image 105, there may also be characters of other complex styles, which are not listed in the embodiments.

In addition, in the embodiments of the present disclosure, the characters in the text image may be Chinese characters, English characters, or characters in other languages, which are not limited in the embodiments. For ease of illustration, English characters are used as examples in the accompanying drawings of the present disclosure.

At present, with the development of artificial intelligence technology, for text images (such as image 101) in the natural scenario, the OCR technology may be used to recognize characters included in such text images. However, for the text images including characters of complex styles (for example, image 102 to image 105), the current text recognition solutions are usually unable to recognize such characters, or have poor recognition results therefor.

The present disclosure provides a text recognition method and apparatus, a model training method and apparatus, a device, a storage medium and a program, which are applicable to the field of artificial intelligence, including technical fields of deep learning, image processing, computer vision and the like. They are intended to provide a text recognition solution capable of recognizing characters of any style.

In the technical solutions of the present disclosure, a text image to be recognized may be acquired, and feature extraction is performed on the text image, to obtain an image feature corresponding to the text image, where a height-wise feature and a width-wise feature of the image feature each have a dimension greater than 1. According to the image feature, sampling features corresponding to multiple sampling points in the text image are determined. Further, according to the sampling features corresponding to the multiple sampling points, a character recognition result corresponding to the text image is determined.

In the above text recognition process, since the height-wise feature and the width-wise feature of the image feature each have a dimension greater than 1, the image feature includes both feature information in the width direction of the image and feature information in the height direction of the image. That is, spatial information of the text image is retained in the image feature. Therefore, the sampling feature corresponding to each sampling point determined according to the image feature can represent a regional feature of a region where the sampling point is located. It can be seen that the spatial information of the text image is considered in the text recognition process. As such, regardless of the style of the characters included in the text image, the characters in the text image can be recognized successfully with the technical solution of the present disclosure. That is to say, the text recognition solution provided by the present disclosure can improve the accuracy of the character recognition result for text images including characters of any style.

The technical solutions of the present disclosure are described in detail below with reference to specific embodiments. The following embodiments can be combined with each other. The same or similar concepts or processes may not be repeated in some embodiments.

FIG. 2 is a schematic flowchart of a text recognition method provided by an embodiment of the present disclosure. As shown in FIG. 2, the method of the embodiment includes operations as follows.

At S201, a text image to be recognized is acquired.

The text image includes one or more characters. The text image may be obtained by photographing or scanning a text line. It is illustrated by taking a case where the text image includes multiple characters as an example, and the technical solutions of this disclosure are also applicable for a case where the text image includes one character.

In the embodiments of the present disclosure, the characters included in the text image may be characters of any style, including but not limited to horizontal characters, curved characters, oblique characters, characters of special font, and handwritten characters in joined-up writing illustrated in FIG. 1, and the like. In addition, in the embodiments of the present disclosure, the characters in the text image may be Chinese characters, English characters, or characters in any other language, which are not limited in this embodiment.

At S202, feature extraction is performed on the text image, to obtain an image feature corresponding to the text image, where a height-wise feature and a width-wise feature of the image feature each have a dimension greater than 1.

In the embodiments of the present disclosure, feature extraction may be implemented by performing convolution processing on the text image. Exemplarily, a convolutional neural network (CNN) may be used to perform feature extraction on the text image, to obtain the image feature. The CNN may be a convolutional neural network of any structure, such as Visual Geometry Group (VGG) of the convolutional neural network, Residual Neural Network (ResNet), Dense Convolutional Network (DenseNet), and MobileNet.

In some possible implementations, in the case where the convolutional neural network is used to perform the feature extraction, the convolutional neural network may also be added therein with an operator to improve the network effect, such as a deformable convolution operator (deform cony), Squeeze-and-Excitation (SE), and dilated convolution operator (dilation cony).

In the embodiments of the present disclosure, after feature extraction is performed on the text image, the height-wise feature and the width-wise feature of the obtained image feature each have a dimension greater than 1. That is to say, the image feature include a feature in the height direction and a feature in the width direction, that is, the spatial information of the text image is retained in the image feature.

In some examples, the image feature may include a channel-wise feature in addition to the height-wise feature and the width-wise feature. That is, the channel-wise feature of the image feature also has a dimension greater than 1.

It is assumed that the height of the text image is H (that is, there are H pixels in each column in the height direction) and the width of the text image is W (that is, there are W pixels in each row in the width direction). When the feature extraction is performed on the text image, down-sampling may be performed according to a preset ratio in the height direction and the width direction, so that the dimension of the height-wise feature and the dimension of the width-wise feature of the image feature are reduced, so as to reduce the calculation amount.

In addition, the text image may also include multiple channels. For example, the text image may have 3 channels (for example, the text image includes three channels, including a red R channel, a green G channel, and a blue B channel). During the feature extraction, the dimension of the channel-wise feature may also be increased, to improve the expressiveness of the image feature.

It is assumed that, after the feature extraction, the height-wise feature of the obtained image feature has a dimension of H/k1, the width-wise feature of the obtained image feature has a dimension of W/k2, and the channel-wise feature of the obtained image feature has a dimension of D. H/k1 is an integer greater than 1 and less than H, and W/k2 is an integer greater than 1 and less than W. k1 represents the down-sampling ratio in the height direction, and k2 represents the down-sampling ratio in the width direction. k1 and k2 may be the same or different.

As an example, it is assumed that k1=4 and k2=4. If the height H of the text image is 32, the width H is 64, and there are 3 channels, then after the feature extraction is performed on the text image (32, 64, 3), the dimension of the obtained image feature is as (8, 16, 128); that is, the dimension of the height-wise feature of the image feature is 8, the dimension of the width-wise feature of the image feature is 16, and the dimension of the channel-wise feature of the image feature is 128.

It should be understood that, since the height-wise feature and the width-wise feature of the extracted image feature each have a dimension greater than 1, the image feature include not only the feature information in the width direction of the image, but also the feature information in the height direction of the image. That is, the spatial information is retained in the image feature.

At S203, according to the image feature, sampling features corresponding to multiple sampling points in the text image are determined.

In the embodiments of the present disclosure, multiple sampling points may be determined in the text image first. The sampling points are key feature points in the text image. In some examples, the multiple sampling points may be determined in the text image according to a preset distribution principle. In other examples, the multiple sampling points may be determined in the text image according to the image feature, for example, a point whose feature satisfies a preset condition is determined as the sampling point.

The number of the sampling points may be greater than or equal to the number of characters included in the text image. That is, when determining the sampling points, one sampling point may be determined in a region corresponding to each character, or multiple sampling points may be determined in the region corresponding to each character. It should be noted that the number of the sampling points is not limited by the embodiments of the present disclosure.

Further, after the multiple sampling points are determined, the sampling feature corresponding to each sampling point may be obtained from the image feature. Since the height-wise feature and the width-wise feature of the image feature each have a dimension greater than 1, that is, the spatial information of the text image is retained in the image feature, the sampling feature corresponding to each sampling point obtained from the image feature can represent the regional feature of the region in the text image where the sampling point is located.

At S204, according to the sampling features corresponding to the multiple sampling points, a character recognition result corresponding to the text image is determined.

The character recognition result includes: at least one character or a character sequence recognized from the text image.

Exemplarily, character recognition may be performed on the sampling feature corresponding to each sampling point, to obtain a character corresponding to the sampling point. Then, based on the characters corresponding to the multiple sampling points, the character recognition result corresponding to the text image is determined.

Since the sampling feature corresponding to each sampling point represents the regional feature of the region in the text image where the sampling point is located, in the embodiments of the present disclosure, during the text recognition, the regional feature of the region where the sampling point is located is considered, that is, the spatial information of the text image is considered. Therefore, even if characters of complex styles are included in the text image, they can also be accurately recognized.

In the text recognition method provided by the embodiments, a text image to be recognized is acquired; feature extraction is performed on the text image, to obtain an image feature corresponding to the text image, where the height-wise feature and the width-wise feature of the image feature each have a dimension greater than 1. According to the image feature, sampling features corresponding to multiple sampling points in the text image are determined. According to the sampling features corresponding to the multiple sampling points, a character recognition result corresponding to the text image is determined. In the above process, since the height-wise feature and the width-wise feature of the image feature each have a dimension greater than 1, the spatial information of the text image is retained in the image feature. Therefore, the sampling feature corresponding to each sampling point obtained from the image feature represents the regional feature of the region where the sampling point is located. That is, in the embodiments of the present disclosure, the spatial information of the text image is considered in the text recognition. Therefore, even if characters of complex styles are included in the text image, they can also be accurately recognized, and the accuracy of the text recognition result is improved.

It can be understood that, regardless of the style of characters included in the text image, the characters in the text image can be recognized successfully with the embodiments of the present disclosure. That is to say, the text recognition solution provided by the present disclosure can improve the accuracy of the character recognition result for text images including characters of any style.

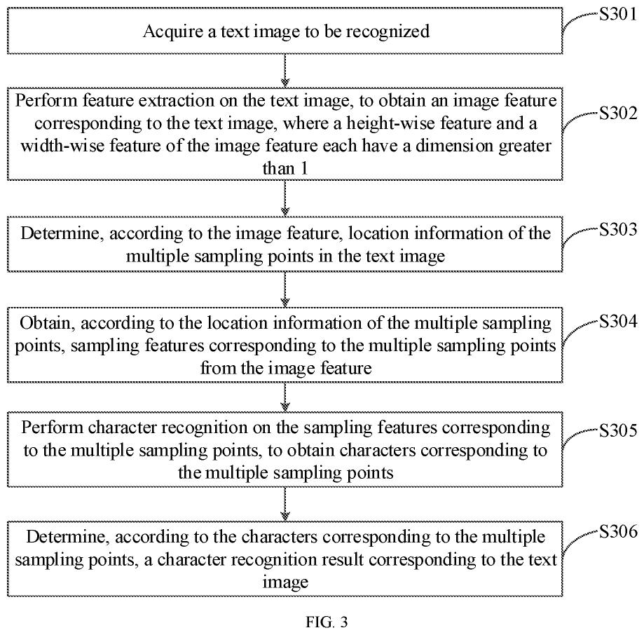

In order to help the reader understand the implementation principle of the present disclosure comprehensively, the embodiment shown in FIG. 2 is further elaborated first in combination with the embodiments shown in FIG. 3 to FIG. 7.

FIG. 3 is a schematic flowchart of another text recognition method provided by an embodiment of the present disclosure. As shown in FIG. 3, the method of the embodiment includes operations as follows.

At S301, a text image to be recognized is acquired.

At S302, feature extraction is performed on the text image, to obtain an image feature corresponding to the text image, where a height-wise feature and a width-wise feature of the image feature each have a dimension greater than 1.

It should be understood that, for the specific implementations of S301 and S302, reference may be made to relevant descriptions of S201 and S202 in FIG. 2, which will not be repeated herein.

At S303, according to the image feature, location information of the multiple sampling points in the text image is determined.

In the embodiments, according to the image feature, multiple key feature points may be determined in the text image; and these key feature points may be used as the sampling points.

It is assumed that the height-wise feature of the image feature has a dimension of H/k1, the width-wise feature of the image feature has a dimension of W/k2, and the channel-wise feature of the image feature has a dimension of D, thus the dimension of the image feature may be indicated as (H/k1, W/k2, D). It should be understood that, if the result of H/k1 or W/k2 is not an integer, it may be rounded down or rounded up.

It is assumed that the number of the multiple sampling points is N. In some possible implementations, the image feature may be processed in the following manner to obtain the location information of the N sampling points.

(1) Pooling is performed on the image feature to obtain a pooled feature, where the height-wise feature and the width-wise feature of the pooled feature each have a dimension of 1, and the channel-wise feature of the pooled feature has a dimension of D; that is, the dimension of the pooled feature is (1, 1, D).

Exemplarily, the image feature may be input into a pooling unit, and the pooling unit performs pooling on the image feature, and outputs the pooled feature. The pooling unit may perform pooling on the image feature in the height direction and the width direction, so as to reduce both the dimension of the height-wise feature and the dimension of the width-wise feature to 1. In this way, the dimension of the obtained pooled feature is (1, 1, D). That is, the pooled feature may be regarded as a vector with a dimension of D.

It should be understood that the above pooling may be average pooling, maximum pooling, and other possible pooling methods, which are not limited in the embodiments.

In some possible implementations, it is also possible to perform non-linear processing on the image feature first to obtain a non-linear feature, and then to perform pooling on the non-linear feature to obtain the pooled feature.

It should be understood that the non-linear processing is used to increase non-linear characteristics of the image feature, so as to improve the expressiveness of the image feature. By performing the non-linear processing on the image feature, the expressiveness of the obtained non-linear feature is higher than that of the image feature.

It should be noted that the manner of performing the non-linear processing is not limited in the embodiments. Exemplarily, a convolution-batch normalization-rectified linear unit (Conv-BN-ReLU) may be used to perform the non-linear processing on the image feature, to map the image feature into the non-linear feature.

(2) Dimension reduction is performed on the channel-wise feature of the pooled feature to obtain a feature vector, where the dimension of the feature vector is N*2.

Exemplarily, the pooled feature with a dimension of D may be input into a linear mapping unit, and the linear mapping unit performs dimension reduction on the pooled feature, and outputs a feature vector with a dimension of N*2.

(3) According to the feature vector, the location information of the N sampling points in the text image is determined.

The above feature vector with a dimension of N*2 may be regarded as coordinates of the N sampling points, where the coordinates of each sampling point include: a coordinate of the sampling point in the height direction of the image, and a coordinate of the sampling point in the width direction of the image. Therefore, the location information of the N sampling points may be obtained according to the coordinates of the N sampling points.

At S304, according to the location information of the multiple sampling points, sampling features corresponding to the multiple sampling points are obtained from the image feature.

After the location information of the multiple sampling points is determined, for each sampling point, the sampling feature corresponding to the sampling point may be obtained from the image feature, according to the location information of the sampling point. Exemplarily, each sampling point in the text image may be projected into the image feature, to determine a projection point corresponding to the sampling point, and a feature corresponding to the projection point is determined as the sampling feature corresponding to the sampling point. The dimension of the sampling feature of each sampling point is D. In this way, the dimensions of the sampling features corresponding to the N sampling points may be indicated as N*D.

At S305, character recognition is performed on the sampling features corresponding to the multiple sampling points, to obtain characters corresponding to the multiple sampling points.

The character corresponding to each sampling point refers to a character included in the region where the sampling point is located in the text image.

For any one of the multiple sampling points, the character recognition is performed on the sampling feature (with a dimension of D) corresponding to the sampling point, to determine a character corresponding to the sampling point. Exemplarily, the character recognition may be performed on the sampling feature corresponding to the sampling point, to obtain a probability that the sampling point corresponds to each of multiple predetermined characters, a maximum probability is determined from the obtained probabilities respectively the multiple predetermined characters, and a predetermined character corresponding to the maximum probability is determined from the multiple predetermined characters, as the character corresponding to the sampling point.

For example, in the scenario where English characters are involved, the multiple predetermined characters may include 26 English characters (character “a” to character “z”) and a space character (−). That is, the number C of the multiple predetermined characters is 27. For each sampling point, the probability that the sampling point corresponds to each of the above 27 predetermined characters is recognized according to the sampling feature corresponding to the sampling point, and a predetermined character corresponding to a maximum probability is determined as the character corresponding to the sampling point.

At S306, according to the characters corresponding to the multiple sampling points, a character recognition result corresponding to the text image is determined. In an implementation, the character recognition result corresponding to the text image may be obtained by arranging the characters corresponding to the multiple sampling points in an order the same as the arrangement of the multiple sampling points; further, other processing may also be performed on the arranged character, such as deduplication processing and blank removal processing described below.

In some scenarios, there is one sampling point in the region occupied by each character of the text image. In this case, the characters corresponding to the multiple sampling points are determined as the character recognition result corresponding to the text image. For example, it is assumed that N=5, the character corresponding to sampling point 1 is “h”, the character corresponding to sampling point 2 is “e”, the character corresponding to sampling point 3 is “l”, the character corresponding to sampling point 4 is “l”, and the character corresponding to sampling point 5 is “o”, the character recognition result corresponding to the text image is “hello”.

In other scenarios, there may be more than one sampling point in the region occupied by each character of the text image. In this case, at least one of deduplication processing and blank removal processing may be performed on the characters corresponding to the multiple sampling points, to obtain the character recognition result corresponding to the text image.

For example, it is assumed that the characters corresponding to N sampling points (N=10) are “hheellllloo” in sequence. Then, the character recognition result “hello” of the text image is obtained after the deduplication processing is performed on the characters.

For another example, it is assumed that the characters corresponding to N sampling points (N-15) are “-hh-ee-ll-ll-oo” in sequence, where the character “-” represents a space character. After the deduplication processing is performed on characters corresponding to the above 15 sampling points, “-h-e-l-l-o” is obtained. Then, the blank removal processing is performed on the result obtained after the deduplication processing, to obtain “hello”, thus the character recognition result of the text image is determined as “hello”.

The text recognition method provided by the embodiments of the present disclosure may be executed by a terminal device, or may also be executed by a server. When it is executed by the terminal device, after obtaining the character recognition result of the text image, the terminal device may also display the character recognition result corresponding to the text image. When it is executed by the server, after obtaining the character recognition result of the text image, the server may send the character recognition result corresponding to the text image to a preset device (such as a terminal device), so that the preset device can display, or further analyze and process, the character recognition result.

In the text processing method provided by the present embodiment, according to the image feature, the location information of multiple sampling points in the text image may be determined; and according to the location information of the multiple sampling points, the sampling features corresponding to the multiple sampling points are obtained from the image feature, so as to determine, according to the sampling features corresponding to the multiple sampling points, the character recognition result corresponding to the text image. For the above process, it is simple to be executed, and there is no need to correct the text image, or to segment the characters in the text image in advance, thus the amount of calculation is small. On the basis of accurately recognizing characters of any style, it also improves the efficiency of text recognition.

On the basis of the embodiment shown in FIG. 3, the text recognition process is described below with reference to an example.

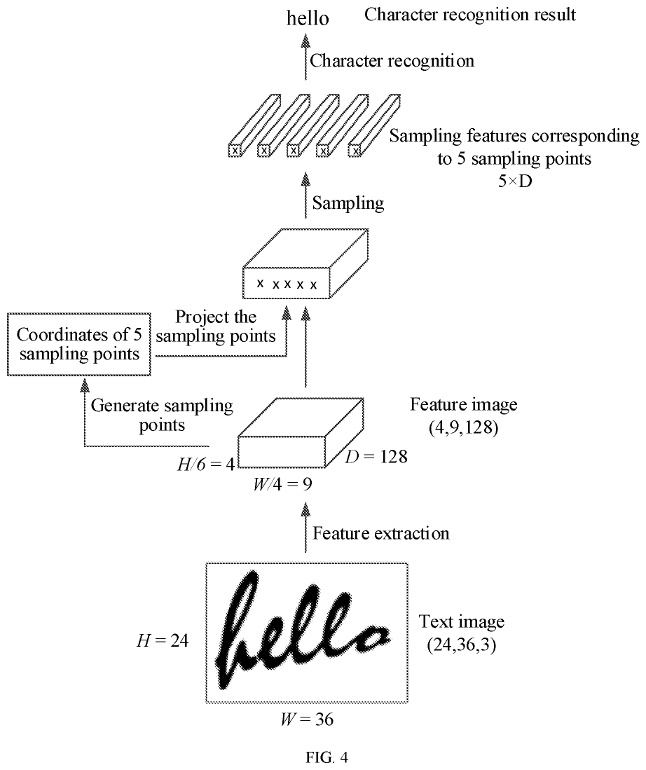

FIG. 4 is a schematic diagram illustrating a text recognition process provided by the embodiments of the present disclosure. As shown in FIG. 4, the recognition process for the text image 105 shown in FIG. 1 is taken as an example for illustration. In this embodiment, it is assumed that the number N of the sampling points is 5, the height H of the text image to be recognized is 24, the width W thereof is 36, and there are 3 channels, that is, the text image may be indicated as (24, 36, 3).

Referring to FIG. 4, the text recognition process is performed as follows.

(1) Feature extraction is performed on the text image, to obtain an image feature.

The dimension of the height-wise feature of the image feature is 4, the dimension of the width-wise feature of the image feature is 9, and the dimension of the channel-wise feature of the image feature is 128, that is, the dimension of the image feature may be indicated as (4, 9, 128).

(2) According to the image feature, the coordinates of 5 sampling points in the text image are determined.

Specifically, non-linear processing is performed on the image feature (4, 9, 128), to obtain a non-linear feature; and pooling is performed on the non-linear feature, to obtain a pooled feature (1, 1, 128). The dimension reduction is performed on the pooled feature with a dimension of 128, to obtain a feature vector with a dimension of 5*2=10. Further, the coordinates of the 5 sampling points are determined according to the feature vector.

(3) The 5 sampling points are projected into the image feature, and the sampling features (5×D) corresponding to the individual sampling points are obtained by sampling from the image feature based on the projection points.

(4) Character recognition is performed on the sampling features corresponding to the 5 sampling points, to obtain a character recognition result “hello”.

It should be understood that, in the example shown in FIG. 4, it is illustrated by taking a case where N=5 as an example. In practical applications, N may also be any value greater than 5, which is not limited in this embodiment.

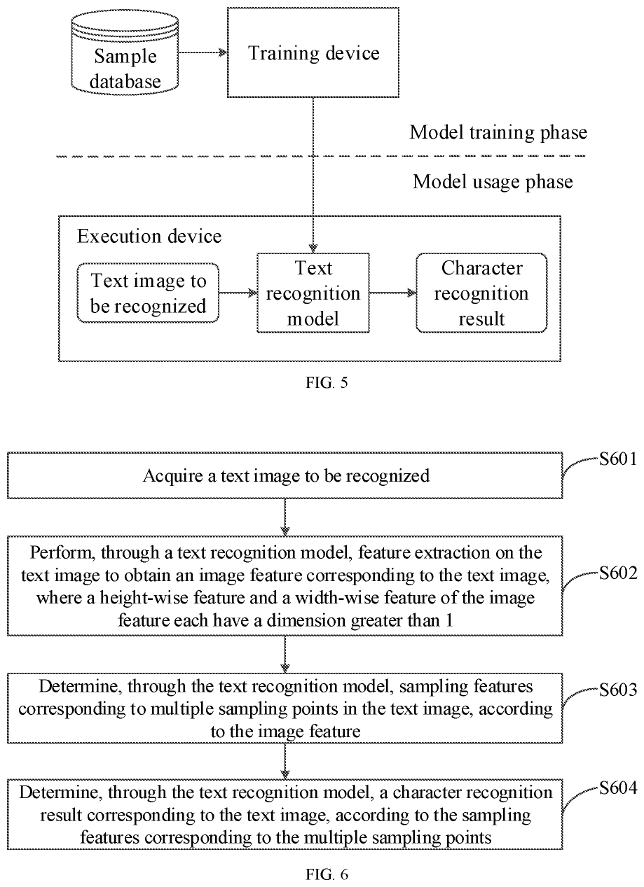

The above embodiments shown in FIG. 2 or FIG. 3 may be implemented by a machine learning model. A possible system architecture provided by the embodiment of the present disclosure is described below with reference to FIG. 5.

FIG. 5 is a schematic diagram of a system architecture involved in the embodiments of the disclosure. As shown in FIG. 5, the system architecture includes a training device and an execution device. The execution device may be an electronic device with a text recognition function, and the training device may be a server. The embodiments of the present disclosure relate to a model training phase and a model usage phase, both of which are respectively explained below.

In the model training phase, the training device may use multiple sets of training samples in a sample database to train a text recognition model to be trained, so as to obtain a trained text recognition model. Each set of training samples includes: a sample text image, and a character labeling result corresponding to the sample text image. The character labeling result includes a character sequence included in the sample text image. It should be understood that the training samples in the sample database cover various styles of characters.

The trained text recognition model may be deployed into the execution device. In the model usage phase, the execution device obtains a text image to be recognized, and performs recognition processing on the text image through the text recognition model, to obtain the character recognition result corresponding to the text image.

The usage process and training process of the text recognition model are described in detail below with reference to FIG. 6 to FIG. 8.

FIG. 6 is a schematic flowchart of a further text recognition method provided by an embodiment of the present disclosure. The text recognition process in the embodiment is specifically implemented by a text recognition model deployed in the execution device. As shown in FIG. 6, the method of this embodiment includes operations as follows.

At S601, a text image to be recognized is acquired.

At S602, feature extraction is performed, through the text recognition model, on the text image to obtain an image feature corresponding to the text image, where a height-wise feature and a width-wise feature of the image feature each have a dimension greater than 1.

At S603, sampling features corresponding to multiple sampling points in the text image are determined, through the text recognition model, according to the image feature.

At S604, a character recognition result corresponding to the text image is determined, through the text recognition model, according to the sampling features corresponding to the multiple sampling points.

That is, S202 to S204 in FIG. 2 may be implemented by the text recognition model. Similarly, S302 to S306 in FIG. 3 may also be implemented by the text recognition model. For the specific processing process of the text recognition model, reference may be made to the detailed description of the embodiment shown in FIG. 2 or FIG. 3, which will not be repeated herein.

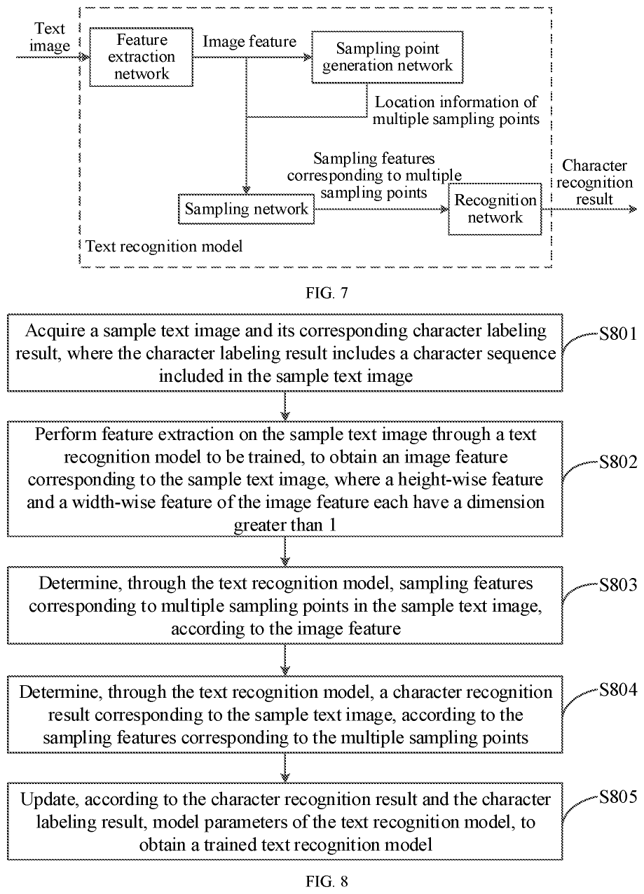

FIG. 7 is a schematic structural diagram of a text recognition model provided by an embodiment of the present disclosure. As shown in FIG. 7, the text recognition model may include a feature extraction network, a sampling point generation network, a sampling network and a recognition network.

Exemplarily, referring to FIG. 7, after the text image is input into the text recognition model, feature extraction is performed on the text image through the feature extraction network, to obtain the image feature corresponding to the text image, and the obtained image feature is input into the sampling point generation network and the sampling network. Through the sampling point generation network, the location information of multiple sampling points in the text image is determined according to the image feature, and the determined location information of the multiple sampling points is input to the sampling network. Through the sampling network, the sampling features corresponding to the multiple sampling points are obtained from the image feature according to the location information of the multiple sampling points, and the obtained sampling features corresponding to the multiple sampling points are input into the recognition network. Recognition processing is performed on the sampling features corresponding to multiple sampling points through the recognition network, and the character recognition result corresponding to the text image is obtained.

With regard to the specific processing of the feature extraction network, the sampling point generation network, the sampling network and the recognition network, reference may be made to the detailed description of the embodiment shown in FIG. 2 or FIG. 3, which will not be repeated herein.

FIG. 6 and FIG. 7 describe the usage process of the text recognition model. The training process of the text recognition model is described in detail below with reference to FIG. 8.

FIG. 8 is a schematic flowchart of a method for training a text recognition model provided by an embodiment of the present disclosure. As shown in FIG. 8, the method of the embodiment includes operations as follows.

At S801, a sample text image and a character labeling result corresponding to the sample text image are acquired, where the character labeling result includes a character sequence included in the sample text image.

In the embodiment, the characters included in the sample text image may be characters of any style, including but not limited to horizontal characters, oblique characters, curved characters, characters of special font, and handwritten characters in joined-up writing illustrated in FIG. 1, and the like. The character labeling result may be obtained by manually labeling the sample text image.

At S802, feature extraction is performed on the sample text image through a text recognition model to be trained, to obtain an image feature corresponding to the sample text image, where a height-wise feature and a width-wise feature of the image feature each have as dimension greater than 1.

At S803, sampling features corresponding to multiple sampling points in the sample text image are determined through the text recognition model, according to the image feature.

At S804, the character recognition result corresponding to the sample text image is determined through the text recognition model, according to the sampling features corresponding to the multiple sampling points.

It should be understood that, in S802 to S804 of the embodiment, the processing on the sample text image by the text recognition model is similar to that in the above embodiments, which will not be repeated herein.

At S805, according to the character recognition result and the character labeling result, model parameters of the text recognition model are updated, to obtain a trained text recognition model.

Exemplarily, a loss function may be determined according to the character recognition result and the character labeling result. And the model parameters of the text recognition model are updated according to the loss function, to obtain the updated text recognition model. Further, it is determined whether the updated text recognition model converges. If it is determined that the updated text recognition model converges, the updated text recognition model is used as the trained text recognition model; and if it is determined that the updated text recognition model does not converge, the training processes of S801 to S805 are repeated until the updated text recognition model converges.

In some possible implementations, the determining, according to the image feature, sampling features corresponding to multiple sampling points in the sample text image of S803 includes: determining, according to the image feature, location information of the multiple sampling points in the sample text image; and obtaining, according to the location information of the multiple sampling points, sampling features corresponding to the multiple sampling points from the image feature.

In a possible implementation, the number of the multiple sampling points is N; the dimension of a channel-wise feature of the image feature is D, where D is an integer greater than N*2; and the determining, according to the image feature, the location information of the multiple sampling points in the sample text image, includes:

performing pooling on the image feature to obtain a pooled feature, where the heightwise feature and the width-wise feature of the pooled feature each have a dimension of 1, and the channel-wise feature of the pooled feature has a dimension of D;

performing dimension reduction on the channel-wise feature of the pooled feature, to obtain a feature vector, where the dimension of the feature vector is N*2; and

determining, according to the feature vector, the location information of the N sampling points in the sample text image.

In a possible implementation, the performing pooling on the image feature to obtain the pooled feature, includes:

performing non-linear processing on the image feature to obtain a non-linear feature; and

performing pooling on the non-linear feature to obtain the pooled feature.

In a possible implementation, the determining, according to the sampling features corresponding to the multiple sampling points, the character recognition result corresponding to the sample text image of S804 includes:

performing character recognition on the sampling features corresponding to the multiple sampling points, to obtain characters corresponding to the multiple sampling points; and

determining, according to the characters corresponding to the multiple sampling points, the character recognition result corresponding to the sample text image.

In a possible implementation, for any one of the multiple sampling points, the performing character recognition on the sampling feature corresponding to the sampling point, to obtain the character corresponding to the sampling point, includes:

performing character recognition on the sampling feature corresponding to the sampling point, to obtain a probability that the sampling point corresponds to each of multiple predetermined characters; and

determining a predetermined character corresponding to a maximum probability, as the character corresponding to the sampling point.

In a possible implementation, the determining, according to the sampling features corresponding to the multiple sampling points, the character recognition result corresponding to the sample text image, includes:

determining the characters corresponding to the multiple sampling points, as the character recognition result corresponding to the sample text image; or

performing at least one of deduplication processing and blank removal processing on the characters corresponding to the multiple sampling points, to obtain the character recognition result corresponding to the sample text image.

In the method for training a text recognition model provided by the embodiment, since the height-wise feature and the width-wise feature of the image feature each have a dimension greater than 1, the image feature includes not only feature information in the height direction of the image, but also feature information in the width direction of the image. That is, the spatial information of the sample text image is retained in the image feature. Therefore, the sampling feature corresponding to each sampling point determined according to the image feature can represent the regional feature of the region where the sampling point is located. It can be seen that the spatial information of the sample text image is considered in the training process of the text recognition model. Therefore, the trained text recognition model in the embodiment can recognize characters of any style, and can improve the accuracy of the text recognition result.

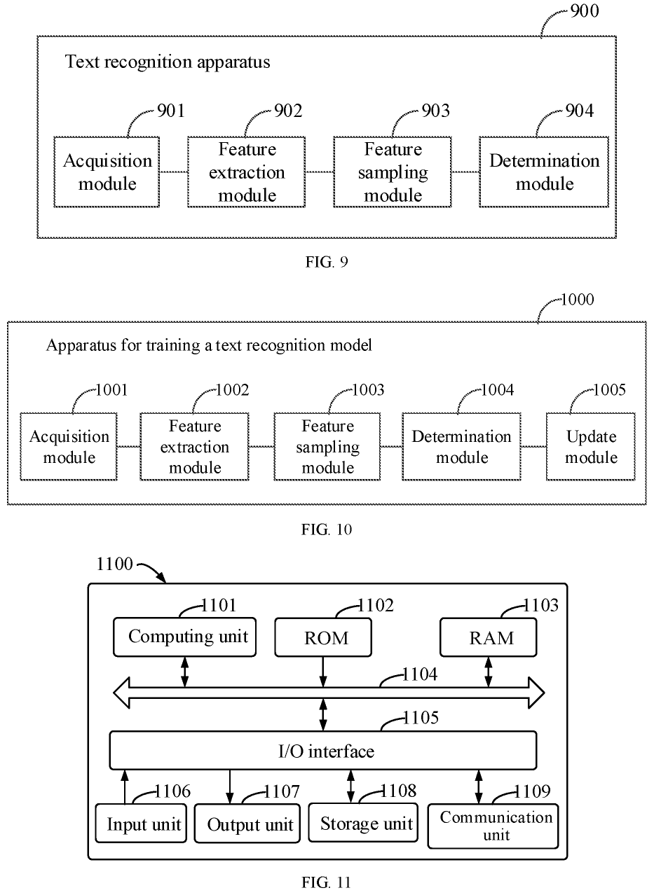

FIG. 9 is a schematic structural diagram of a text recognition apparatus provided by an embodiment of the present disclosure. The apparatus may be in the form of software and/or hardware. Exemplarily, the apparatus may be an execution device, or a module, a unit, a chip, a chip module or the like deployed in the execution device. As shown in FIG. 9, the text recognition apparatus 900 provided in the embodiment includes an acquisition module 901, a feature extraction module 902, a feature sampling module 903 and a determination module 904.

The acquisition module 901 is configured to acquire a text image to be recognized.

The feature extraction module 902 is configured to perform feature extraction on the text image, to obtain an image feature corresponding to the text image, where a height-wise feature and a width-wise feature of the image feature each have a dimension greater than 1.

The feature sampling module 903 is configured to determine, according to the image feature, sampling features corresponding to multiple sampling points in the text image.

The determination module 904 is configured to determine a character recognition result corresponding to the text image, according to the sampling features corresponding to the multiple sampling points.

In a possible implementation, the feature sampling module 903 includes:

a first determination unit, configured to determine, according to the image feature, location information of the multiple sampling points in the text image; and

a sampling unit, configured to obtain the sampling features corresponding to the multiple sampling points from the image feature, according to the location information of the multiple sampling points.

In a possible implementation, the number of the multiple sampling points is N, the dimension of a channel-wise feature of the image feature is D, where D is an integer greater than N*2; and the first determination unit includes:

a first processing subunit, configured to perform pooling on the image feature, to obtain a pooled feature, where a height-wise feature and a width-wise feature of the pooled feature each have a dimension of 1, and a channel-wise feature of the pooled feature has a dimension of D;

a second processing subunit, configured to perform dimension reduction on the channel-wise feature of the pooled feature, to obtain a feature vector, where the dimension of the feature vector is N*2; and

a first determination subunit, configured to determine the location information of the N sampling points in the text image, according to the feature vector.

In a possible implementation, the first processing subunit is specifically configured to:

perform non-linear processing on the image feature to obtain a non-linear feature; and

perform pooling on the non-linear feature to obtain the pooled feature.

In a possible implementation, the determination module 904 includes:

a recognition unit, configured to perform character recognition on the sampling features corresponding to the multiple sampling points, to obtain characters corresponding to the multiple sampling points; and

a second determination unit, configured to determine the character recognition result corresponding to the text image, according to the characters corresponding to the multiple sampling points.

In a possible implementation, the recognition unit includes a recognition subunit and a second determination subunit, and for any one of the multiple sampling points:

the recognition subunit is configured to perform character recognition on the sampling feature corresponding to the sampling point, to obtain a probability that the sampling point corresponds to each of multiple predetermined characters; and

the second determination subunit is configured to determine a predetermined character corresponding to a maximum probability, as the character corresponding to the sampling point.

In a possible implementation, the second determination unit includes:

a third determination subunit, configured to determine the characters corresponding to the multiple sampling points, as the character recognition result corresponding to the text image; or

a fourth determination subunit, configured to perform at least one of deduplication processing and blank removal processing on the characters corresponding to the multiple sampling points, to obtain the character recognition result corresponding to the text image.

In a possible implementation, the feature extraction module 902 is specifically configured to perform, through a text recognition model, feature extraction on the text image, to obtain the image feature corresponding to the text image.

The feature sampling module 903 is specifically configured to determine, through the text recognition model, the sampling features corresponding to the multiple sampling points in the text image, according to the image feature.

The determination module 904 is specifically configured to determine, through the text recognition model, the character recognition result corresponding to the text image, according to the sampling features corresponding to the multiple sampling points.

In a possible implementation, the apparatus provided by the embodiment further includes:

a display module, configured to display the character recognition result corresponding to the text image; or

a transmission module, configured to transmit the character recognition result corresponding to the text image to a preset device.

The text recognition apparatus provided in the embodiment may be used to execute the text recognition method provided by any of the above method embodiments, where the implementation principles and technical effects are similar to those mentioned above, which will not be repeated herein.

FIG. 10 is a schematic structural diagram of an apparatus for training a text recognition model provided by an embodiment of the present disclosure. The apparatus may be in the form of software and/or hardware. Exemplarily, the apparatus may be a training device, or a module, a unit, a chip, a chip module or the like deployed in the training device. As shown in FIG. 10, the apparatus 1000 for training a text recognition model provided in the embodiment includes an acquisition module 1001, a feature extraction module 1002, a feature sampling module 1003, a determination module 1004 and an update module 1005.

The acquisition module 1001 is configured to acquire a sample text image and a character labeling result corresponding to the sample text image, where the character labeling result includes a character sequence included in the sample text image.

The feature extraction module 902 is configured to perform, through a text recognition model to be trained, feature extraction on the sample text image, to obtain an image feature corresponding to the sample text image, where a height-wise feature and a width-wise feature of the image feature each have a dimension greater than 1.

The feature sampling module 1003 is configured to determine, through the text recognition model, sampling features corresponding to multiple sampling points in the sample text image, according to the image feature.

The determination module 1004 is configured to determine, through the text recognition model, a character recognition result corresponding to the sample text image, according to the sampling features corresponding to the multiple sampling points.

The update module 1005 is configured to update, according to the character recognition result and the character labeling result, model parameters of the text recognition model, to obtain a trained text recognition model.

In some possible implementations, the feature sampling module 1003 includes:

a first determination unit, configured to determine location information of the multiple sampling points in the sample text image, according to the image feature; and

a sampling unit, configured to obtain the sampling features corresponding to the multiple sampling points from the image feature, according to the location information of the multiple sampling points.

In some possible implementations, the number of the multiple sampling points is N, the dimension of a channel-wise feature of the image feature is D, where D is an integer greater than N*2, and the first determination unit includes:

a first processing subunit, configured to perform pooling on the image feature, to obtain a pooled feature, where a height-wise feature and a width-wise feature of the pooled feature each have a dimension of 1, and a channel-wise feature of the pooled feature has a dimension of D;

a second processing subunit, configured to perform dimension reduction on the channel-wise feature of the pooled feature, to obtain a feature vector, where the dimension of the feature vector is N*2; and

a first determination subunit, configured to determine the location information of the N sampling points in the sample text image, according to the feature vector.

In a possible implementation, the first processing subunit is specifically configured to:

perform non-linear processing on the image feature to obtain a non-linear feature; and

perform pooling on the non-linear feature to obtain the pooled feature.

In a possible implementation, the determination module 1004 includes:

a recognition unit, configured to perform character recognition on the sampling features corresponding to the multiple sampling points, to obtain characters corresponding to the multiple sampling points; and

a second determination unit, configured to determine the character recognition result corresponding to the sample text image, according to the characters corresponding to the multiple sampling points.

In a possible implementation, the recognition unit includes a recognition subunit and a second determination subunit, for any one of the multiple sampling points:

the recognition subunit is configured to perform character recognition on the sampling feature corresponding to the sampling point, to obtain a probability that the sampling point corresponds to each of multiple predetermined characters; and

the second determination subunit is configured to determine a predetermined character corresponding to a maximum probability, as the character corresponding to the sampling point.

In a possible implementation, the second determination unit includes:

a third determination subunit, configured to determine the characters corresponding to the multiple sampling points, as the character recognition result corresponding to the sample text image; or

a fourth determination subunit, configured to perform at least one of deduplication processing and blank removal processing on the characters corresponding to the multiple sampling points, to obtain the character recognition result corresponding to the sample text image.

The apparatus for training a text recognition model provided in the embodiment may be used to execute the method for training a text recognition model provided by any of the above method embodiments, where the implementation principles and technical effects are similar to those mentioned above, which will not be repeated herein.

According to the embodiments of the present disclosure, the present disclosure further provides an electronic device, a non-transitory readable storage medium, and a computer program product.

According to the embodiments of the present disclosure, the present disclosure further provides a computer program product. The computer program product includes a computer program stored in a readable storage medium. At least one processor of the electronic device may read the computer program from the readable storage medium, and the at least one processor executes the computer program to cause the electronic device to perform the solution provided by any of the foregoing embodiments.

FIG. 11 is a schematic block diagram of an exemplary electronic device 1100 for implementing the embodiments of the present disclosure. The electronic device is intended to represent various types of digital computers, such as a laptop, desktop, workstation, personal digital assistant, server, blade server, mainframe computer, and other suitable computers. The electronic device may also represent various types of mobile devices, such as a personal digital processor, cellular phone, smart phone, wearable device, and other similar computing devices. The components, their connections and relationships, as well as their functions shown herein are only exemplary, and are not intended to limit implementations of the present disclosure described and/or claimed herein.

As shown in FIG. 11, the device 1100 includes a computing unit 1101, which may perform, according to a computer program stored in a read-only memory (ROM) 1102 or a computer program loaded from a storage unit 1108 onto a random access memory (RAM) 1103, various appropriate actions and processes. In the RAM 1103, various programs and data required for the operations of the device 1100 may also be stored. The computing unit 1101, the ROM 1102, and the RAM 1103 are connected to each other through a bus 1104. An input/output (I/O) interface 1105 is also connected to the bus 1104.

Multiple components in the device 1100 are connected to the I/O interface 1105, including: an input unit 1106, such as a keyboard and a mouse; an output unit 1107, such as various types of displays and speakers; the storage unit 1108, such as a magnetic disk and an optical disc; and a communication unit 1109, such as a network card, a modem, and a wireless communication transceiver. The communication unit 1109 allows the device 1100 to exchange information/data with other devices through a computer network such as the Internet and/or various telecommunication networks.

The computing unit 1101 may be various general-purpose and/or special-purpose processing components with processing and computing capabilities. Some examples of the computing unit 1101 include, but are not limited to, central processing unit (CPU), graphics processing unit (GPU), various dedicated artificial intelligence (AI) computing chips, various computing units that executes machine learning model algorithms, digital signal processor (DSP), and any appropriate processor, controller, microcontroller, etc. The computing unit 1101 performs the various methods and processing described above, for example, the text recognition method or the method for training a text recognition model. For example, in some embodiments, the text recognition method or the method for training a text recognition model may be implemented as a computer software program, which is tangibly contained in a machine-readable medium, such as the storage unit 1108. In some embodiments, a part or all of the computer program may be loaded and/or installed on the device 1100 via the ROM 1102 and/or the communication unit 1109. When the computer program is loaded into the RAM 1103 and executed by the computing unit 1101, one or more steps of the text recognition method or the method for training a text recognition model described above may be performed. Alternatively, in other embodiments, the computing unit 1101 may be configured to perform, in any other suitable manner (for example, by means of firmware), the text recognition method or the method for training a text recognition model.

Various implementations of the systems and techniques described above may be embodied in a digital electronic circuit system, an integrated circuit system, a field programmable gate array (FPGA), an application specific integrated circuit (ASIC), an application specific standard product (ASSP), a system-on-a-chip (SOC) system, a complex programmable logic device (CPLD), computer hardware, firmware, software, and/or combinations thereof These various implementations may be embodied in one or more computer programs, the one or more computer programs may be executed and/or interpreted on a programmable system including at least one programmable processor. The programmable processor may be a dedicated or general programmable processor, and may receive/transmit data and instructions from/to a storage system, at least one input apparatus, and at least one output apparatus.

The program codes used to implement the methods of the present disclosure may be written in any combination of one or more programming languages. These program codes may be provided to the processor or controller of a general-purpose computer, a special-purpose computer, or other programmable data processing devices, so that the program codes, when being executed by the processor or controller, cause the functions/operations specified in the flowchart and/or block diagram to be implemented. The program codes may be executed wholly or partly on a machine, and the program codes may be executed, as an independent software package, partly on the machine and partly on a remote machine, or the program codes may be executed wholly on the remote machine or server.

In the context of the present disclosure, the machine-readable medium may be a tangible medium that may contain or store a program for use by, or for use together with, an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or may be any suitable combination thereof. More specific examples of the machine-readable storage media may include electrical connection based on one or more wires, portable computer disk, hard disk, RAM, ROM, erasable programmable read-only memory (EPROM, or flash memory), optical fiber, portable compact disk read-only memory (CD-ROM), optical storage device, magnetic storage device, or any appreciate combination thereof.

In order to provide interaction with the user, the systems and techniques described herein may be implemented on a computer, and the computer has: a display device (for example, a cathode ray tube (CRT) or liquid crystal display (LCD) monitor) for displaying information to the user; and a keyboard and a pointing device (for example, a mouse or a trackball), where the user may provide input to the computer through the keyboard and the pointing device. Other types of devices may also be used to provide interaction with the user. For example, the feedback provided to the user may be any form of sensory feedback (for example, visual feedback, auditory feedback or tactile feedback); and the input from the user may be received in any form (including sound input, voice input or tactile input).

The systems and technologies described herein may be implemented in a computing system that includes back-end components (for example, a data server), or in a computing system that includes middleware components (for example, an application server), or in a computing system that includes front-end components (for example, a user computer with a graphical user interface or web browser, through which the user may interact with the implementation of the system and technology described herein), or in a computing system that includes any combination of such back-end components, middleware components, or front-end components. The components of the system may be connected to each other through any form or medium of digital data communication (for example, a communication network). Examples of the communication network include: local area network (LAN), wide area network (WAN) and the Internet.

The computer system may include a client and a server. The client and server are generally far away from each other and usually interact with each other through a communication network. The relationship between the client and the server is generated through computer programs running on the respective computers and having a client-server relationship with each other. The server may be a cloud server, which is also called cloud computing server or cloud host, and it is a host product in the cloud computing service system for solving the defects of difficult management and weak business expansion in the traditional physical host and Virtual Private Server (VPS). The server may also be a server of a distributed system, or a server combined with a block chain.

It should be understood that the various forms of processes shown above may be reordered, added with a step or made a step deleted therefrom. For example, the steps described in the present disclosure may be performed in parallel, sequentially, or in a different order, as long as the desired result of the technical solution disclosed in the present disclosure can be achieved, which is not limited herein.

The above specific implementations do not constitute a limitation on the scope of protection of the present disclosure. Those skilled in the art should understand that various modifications, combinations, sub-combinations, and substitutions can be made according to design requirements and other factors. Any amendments, equivalent substitutions and improvements, made within the spirit and principles of the present disclosure, shall be included in the scope of protection of the present disclosure.

What is claimed is:

1. A text recognition method, comprising:
performing feature extraction on a text image to be recognized, to obtain an image feature corresponding to the text image, wherein a height-wise feature and a width-wise feature of the image feature each have a dimension greater than 1;
determining, according to the image feature, sampling features corresponding to a plurality of sampling points in the text image; and
determining, according to the sampling features corresponding to the plurality of sampling points, a character recognition result corresponding to the text image.

2. The method according to claim 1, wherein the determining, according to the image feature, sampling features corresponding to a plurality of sampling points in the text image, comprises:
determining, according to the image feature, location information of the plurality of sampling points in the text image; and
obtaining, according to the location information of the plurality of sampling points, sampling features corresponding to the plurality of sampling points from the image feature.

3. The method according to claim 2, wherein the number of the plurality of sampling points is N, a dimension of a channel-wise feature of the image feature is D, where D is an integer greater than N*2; and the determining, according to the image feature, location information of the plurality of sampling points in the text image, comprises:
performing pooling on the image feature to obtain a pooled feature, wherein a height-wise feature and a width-wise feature of the pooled feature each have a dimension of 1, and a channel-wise feature of the pooled feature has a dimension of D;
performing dimension reduction on the channel-wise feature of the pooled feature, to obtain a feature vector, wherein a dimension of the feature vector is N*2; and
determining, according to the feature vector, the location information of the N sampling points in the text image.

4. The method according to claim 3, wherein the performing pooling on the image feature to obtain a pooled feature, comprises:
performing non-linear processing on the image feature to obtain a non-linear feature; and
performing pooling on the non-linear feature to obtain the pooled feature.

5. The method according to claim 2, wherein the obtaining, according to the location information of the plurality of sampling points, sampling features corresponding to the plurality of sampling points from the image feature, comprises:
for each of the plurality of sampling points,
projecting the sampling point into the image feature according to the location information of the sampling point;
determining a projection point on the image feature that corresponds to the sampling point; and
determining a feature corresponding to the projection point as a sampling feature corresponding to the sampling point.

6. The method according to claim 1, wherein the determining, according to the sampling features corresponding to the plurality of sampling points, a character recognition result corresponding to the text image, comprises:
performing character recognition on the sampling features corresponding to the plurality of sampling points, to obtain characters corresponding to the plurality of sampling points; and
determining, according to the characters corresponding to the plurality of sampling points, the character recognition result corresponding to the text image.

7. The method according to claim 6, wherein the performing character recognition on the sampling features corresponding to the plurality of sampling points to obtain characters corresponding to the plurality of sampling points, comprises:
for each of the plurality of sampling points,
performing character recognition on a sampling feature corresponding to the sampling point, to obtain a probability that the sampling point corresponds to each of a plurality of predetermined characters; and
determining, from the plurality of predetermined characters, a predetermined character corresponding to a maximum probability, as a character corresponding to the sampling point.

8. The method according to claim 6, wherein the determining, according to the characters corresponding to the plurality of sampling points, the character recognition result corresponding to the text image, comprises:
determining the characters corresponding to the plurality of sampling points, as the character recognition result corresponding to the text image; or
performing at least one of deduplication processing and blank removal processing on the characters corresponding to the plurality of sampling points, to obtain the character recognition result corresponding to the text image.

9. The method according to claim 1, wherein the performing feature extraction on the text image to obtain an image feature corresponding to the text image, comprises:
performing feature extraction on the text image through a text recognition model, to obtain the image feature corresponding to the text image;
the determining, according to the image feature, sampling features corresponding to a plurality of sampling points in the text image, comprises:
determining, through the text recognition model, the sampling features corresponding to the plurality of sampling points in the text image, according to the image feature; and
the determining, according to the sampling features corresponding to the plurality of sampling points, a character recognition result corresponding to the text image, comprises:
determining, through the text recognition model, the character recognition result corresponding to the text image, according to the sampling features corresponding to the plurality of sampling points.

10. The method according to claim 1, further comprising:
displaying the character recognition result corresponding to the text image; or
transmitting the character recognition result corresponding to the text image to a preset device.

11. The method according to claim 9, wherein the text recognition model is trained by:
acquiring a sample text image and a character labeling result corresponding to the sample text image, wherein the character labeling result comprises a character sequence included in the sample text image;
performing, through a text recognition model to be trained, feature extraction on the sample text image, to obtain a sample image feature corresponding to the sample text image, wherein a height-wise feature and a width-wise feature of the sample image feature each have a dimension greater than 1;
determining, through the text recognition model to be trained, sampling features corresponding to a plurality of sampling points in the sample text image, according to the sample image feature;
determining, through the text recognition model to be trained, a sample character recognition result corresponding to the sample text image, according to the sampling features corresponding to the plurality of sampling points in the sample text image; and
updating, according to the sample character recognition result and the character labeling result, model parameters of the text recognition model to be trained, to obtain a trained text recognition model.

12. An electronic device, comprising:
at least one processor; and
a memory communicating with the at least one processor;
wherein the memory stores instructions executable by the at least one processor, and the instructions, when being executed by the at least one processor, cause the at least one processor to:
perform feature extraction on a text image to be recognized, to obtain an image feature corresponding to the text image, wherein a height-wise feature and a width-wise feature of the image feature each have a dimension greater than 1;
determine, according to the image feature, sampling features corresponding to a plurality of sampling points in the text image; and
determine, according to the sampling features corresponding to the plurality of sampling points, a character recognition result corresponding to the text image.

13. The electronic device according to claim 12, wherein the instructions, when being executed by the at least one processor, further cause the at least one processor to:
determine location information of the plurality of sampling points in the text image, according to the image feature; and
obtain the sampling features corresponding to the plurality of sampling points from the image feature, according to the location information of the plurality of sampling points.

14. The electronic device according to claim 13, wherein the number of the plurality of sampling points is N, a dimension of a channel-wise feature of the image feature is D, where D is an integer greater than N*2; and the instructions, when being executed by the at least one processor, further cause the at least one processor to:
perform pooling on the image feature, to obtain a pooled feature, wherein a height-wise feature and a width-wise feature of the pooled feature each have a dimension of 1, and a channel-wise feature of the pooled feature has a dimension of D;
perform dimension reduction on the channel-wise feature of the pooled feature, to obtain a feature vector, wherein a dimension of the feature vector is N*2; and
determine the location information of the N sampling points in the text image, according to the feature vector.

15. The electronic device according to claim 14, wherein the instructions, when being executed by the at least one processor, further cause the at least one processor to:
performing non-linear processing on the image feature to obtain a non-linear feature; and
performing pooling on the non-linear feature to obtain the pooled feature.

16. The electronic device according to claim 12, wherein the instructions, when being executed by the at least one processor, further cause the at least one processor to:
for any one of the plurality of sampling points, perform character recognition on a sampling feature corresponding to the sampling point, to obtain a probability that the sampling point corresponds to each of a plurality of predetermined characters; and determine, from the plurality of predetermined characters, a predetermined character corresponding to a maximum probability, as a character corresponding to the sampling point; and
determine the character recognition result corresponding to the text image, according to the characters respectively corresponding to the plurality of sampling points.

17. The electronic device according to claim 16, wherein the instructions, when being executed by the at least one processor, further cause the at least one processor to:
determine the characters corresponding to the plurality of sampling points, as the character recognition result corresponding to the text image; or
perform at least one of deduplication processing and blank removal processing on the characters corresponding to the plurality of sampling points, to obtain the character recognition result corresponding to the text image.

18. The electronic device according to claim 12, wherein the instructions, when being executed by the at least one processor, further cause the at least one processor to:
perform, through a text recognition model, feature extraction on the text image, to obtain the image feature corresponding to the text image;
determine, through the text recognition model, the sampling features corresponding to the plurality of sampling points in the text image, according to the image feature; and
determine, through the text recognition model, the character recognition result corresponding to the text image, according to the sampling features corresponding to the plurality of sampling points.

19. The electronic device according to claim 12, wherein the instructions, when being executed by the at least one processor, further cause the at least one processor to:
display the character recognition result corresponding to the text image; or
transmit the character recognition result corresponding to the text image to a preset device.

20. A non-transitory computer-readable storage medium storing computer instructions, wherein the computer instructions are configured to cause a computer to perform a text recognition method comprising:
acquiring an image to be recognized, wherein the image comprises at least one character;
performing feature extraction on the image, to obtain an image feature corresponding to the image, wherein a height-wise feature and a width-wise feature of the image feature each have a dimension greater than 1;
determining, according to the image feature, sampling features corresponding to a plurality of sampling points in the image; and
determining, according to the sampling features corresponding to the plurality of sampling points, a character recognition result for the at least one character of the image.
